(19) United States
(12) Patent Application Publication
(10) Pub. No.: US 2009/0095179 A1
(43) Pub. Date: Apr. 16, 2009

(54) Method for cleaning printing plates

(75) Inventors: Gerhard Augsberg, Seligenstadt (DE); Ulrich Jung, Limbrug (DE); Jurgen Scholzig, Mainz (DE); Lothar Simon, Rodgau (DE)

Correspondence Address: COHEN, PONTANI, LIEBERMAN & PAVANE LLP, 551 FIFTH AVENUE, SUITE 1210, NEW YORK, NY, 10176, US

(73) Assignee: manroland AG, Offenbach am Main (DE)

(21) Appl. No.: 12/284,220

(22) Filed: Sep. 18, 2008

Related U.S. Application Data
(63) Continuation of application No. PCT/EP2006/011634, filed on Dec. 5, 2006.

(30) Foreign Application Priority Data
Dec. 27, 2005 (DE) 10 2005 063 309.9
Mar. 18, 2006 (DE) 10 2006 012 597.5
Jun. 8, 2006 (DE) 10 2006 026 658.7

(51) Int. Cl. B41F 31/00

(52) U.S. Cl. 101/350.1

(57) ABSTRACT

An inking unit in a printing machine having an ink dispensing system comprising an inking roller and a form cylinder carrying at least one printing form. The inking roller transfers printing ink arriving thereon to at least one printing form positioned on the form cylinder. The printing ink is transferable from a respective printing form to print sheets moved between the form cylinder and an impression cylinder. The inking roller is also adjustable relative to the form cylinder. An engagement and/or disengagement of the inking roller relative to the form cylinder and/or an engagement and/or disengagement of a print blanket cylinder or form cylinder relative to the impression cylinder is performable such that print sheets become can be imprinted with a residual ink image by residual ink remaining on the plate cylinder or print blanket cylinder in a printing ON setting with the ink supply disengaged.

### CROSS REFERENCE TO RELATED APPLICATIONS

This application is a Continuation of PCT/EP2006/011634 filed on Dec. 5, 2006 which claims priority from DE 10 2005 063 309 filed on Dec. 27, 2005, DE 10 2006 012 597.5 filed on Mar. 18, 2006, and DE 10 2006 026 658 filed on Jun. 8, 2006.

### BACKGROUND OF THE INVENTION

1. Field of the Invention

The invention is directed to an inking unit of a printing machine and method for operating inking units in printing machines.

2. Description of the Related Art

In printing, a substrate is moved through a plurality of printing units and a partial print image is applied to the substrate in each printing unit. In color printing, the substrate is usually moved through at least four printing units to apply partial print images to the substrate in the process colors black, cyan, magenta and yellow. Partial print images in special colors can be applied to the substrate in additional printing units. Finally, one or more coatings can be applied to print images that have been generated in this way either for protective purposes, to produce textures or to produce glossy or matte effects.

It is already known from DE 33 12 128 A1 to determine a quantity of print sheets by means of a control device which are to be fed to a corresponding coating unit before printing is switched off to minimize the thickness of a layer of residual varnish on a coating roller and on a coating form, or every coating form, positioned on a form cylinder after switching off printing in printing units. Here, however, the question of how to adjust the coating roller and form cylinder is not addressed. Therefore, print sheets are only partially imprinted in such a disclosed printing unit with a coating image during pre-coating when the coating unit is switched from a printing OFF setting to a printing ON setting and during so-called coating removal when the coating unit is switched from the printing ON setting to the printing OFF setting. As a result, print sheets which are provided with only a partial coating image are unusable and must be sorted out as waste paper. This is also a problem for printing units of a printing machine and for the inking units provided therein.

Similarly, EP 0 983 852 B1 discloses a method and a device for regulating the layer thickness of an ink film for a multi-color printing machine. This reference states that plate cylinders which hold a printing plate bearing the print image are provided in printing units. Typically, printing plates of this kind must be changed. The printing plates are provided with printing ink in various ways. Here, it is suggested that a predetermined quantity of print sheets that may be passed through the printing units where a printing plate is to be changed while the ink feed at the inking unit is switched off. As a result, the thickness of the ink layer on the inking rollers of the inking unit, becomes reduced, which makes it easier to switch to a new ink profile. However, the corresponding printing plates are only cleaned to a limited extent because the inking units continue to supply the plates with printing ink, although in a reduced amount. Accordingly, for the plate change, the available printing plate is still soiled in this case, particularly because a relatively large amount of ink is also accumulated on a plurality of inking rollers in conventional inking units, e.g., the inking rollers of offset printing presses.

Accordingly, a decision must be made whenever changing jobs on how the printing plates should be stored for repeat jobs. For this purpose, printing plates can be cleaned by the inking unit before removal or can be removed by the plate changer while still covered with ink, and then externally cleaned manually. This results in an untimely soiling of the plate changing elements.

### SUMMARY OF THE INVENTION

It is therefore an object of the present invention to provide a method for operating printing units, coating units and inking units in printing machines.

This and other object and advantages are achieved by an inking unit and, in a printing machine, by a method in which at least the inking rollers cooperate directly with the form cylinder and, therefore, also with the printing plate such that the inking rollers are engageable and/or disengageable relative to the form cylinder and/or the form cylinder is engageable and/or disengageable relative to the impression cylinder such that a printing plate fitted to the form cylinder is substantially cleaned at the conclusion of the printing process. To achieve this, the ink feed to the printing plate is interrupted by disengaging the inking rollers of the inking unit so that the print sheets can be imprinted only by printing ink from the surface of the printing plate or from the surface of the print blanket cylinder during printing.

The printing unit in according with the invention permits the engagement and disengagement of the inking rollers and of the print blanket cylinder is performed to permit print sheets to be imprinted during printing with an ink image formed of residual printing ink remaining on the form cylinder and print blanket cylinder, and such that no printing ink is applied to the printing plate from the inking unit. As a result, an ink image is printed on a quantity of print sheets, respectively, with a continuously decreasing application of ink, i.e., with a reduced ink layer thickness. It thus becomes possible to generate these as waste sheets shortly before printing is stopped, and can be eliminated from the production process.

The disclosed method of the invention advantageously permits the ink layer that still remains on the surface of the printing plate to be reduced very quickly through the cooperation of the form cylinder and print blanket cylinder virtually simultaneously, by transferring to the substrate imprinted at the print blanket cylinder. In particular, the ink layer is reduced to a very small layer thickness after only a few revolutions of the two cylinders by the splitting in half of the remaining ink layer.

A selectable quantity of sheets for de-inking can be entered in a control terminal of the corresponding printing machine by means of a de-inking control, and any residual ink remaining on the printing plate is removed by printing on the sheets. At the conclusion of a print run, a quantity of waste sheets placed in a feed stack can be used for this purpose.

Accordingly, many additional cleaning tasks can be eliminated, resulting in further special advantages for the handling of the printing machine:

1. The print blanket cylinder is already substantially free of ink and a time-consuming cleaning by a washing device is no longer necessary.

2. The printing plates are now substantially free of ink and can also be exchanged easily using automatic plate changers, without soiling the complicated mechanism of the latter and, thereby, risking a malfunction.

3. Compared to the cleaning of the printing plates by the inking unit, the de-inking control offers the advantage that plate capillaries are not clogged by ink particles and detergent particles which would make reuse of the printing plate more difficult.

In connection with an on-the-fly plate change, it is also possible to exchange printing plates at individually selected plate cylinders in printing machines with individual drives. Here, it is also possible to remove ink from the print blanket cylinder by running print sheets at the end of a print run in the special printing unit that is taken out of the printing process for changing plates. As a result, the print blanket cylinder is not washed during a washing installation and the special printing plate need not be cleaned separately. Naturally, the inking rollers are also disengaged beforehand for this operation. In this way, there is an additional removal of ink from the printing plate at the end of a production run.

The possibility to remove the majority of the remaining residual ink by using waste sheets is provided to permit removal of the printing plates from the printing machine without having to include a washing process and without excessively soiling the transport rollers of an automatic plate changer. Moreover, with the print blanket cylinder engaged, the inking rollers and dampening rollers are disengaged from the plate cylinder at the moment of a preselectable quantity of sheets prior to the final cessation of printing. The quantity of sheets is predetermined in a printer menu at the control device of the printing machine, e.g., at a control terminal. For example, a value ranging from 0 to 100 can be entered at the control terminal to determine this quantity. In practice, up to 65 de-inking sheets are used. When production is terminated by the expiration of a circulation counter of the printer control or by a control button at the control terminal, inking rollers and dampening rollers are automatically switched off earlier while printing continues, and the corresponding quantity of print sheets is transported through the printing machine.

The inking rollers and dampening rollers are advantageously disengaged simultaneously because less ink is removed when the inking roller alone is disengaged, resulting in an inferior cleaning action. Alternatively, a delayed or separate disengagement of the dampening rollers is used for special subjects, substrates or printing inks.

The method according to the invention is advantageously improved by performing the disengagement of the coating units in a printing machine having one or more coating units for additional coating of the print sheets at least with a delay relative to the disengagement of the inking rollers and dampening rollers within the framework of de-inking. Here, coating removal can also be provided and a residual amount of coating can be removed from the coating units. In accordance with the invention, the disengagement should not be performed until the amount of ink remaining on the plate cylinder and print blanket cylinder is minimized to reliably prevent separation of printing ink from the print sheet on coating forms or print blankets in the coating unit(s).

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic illustration of the printing unit of a printing machine in accordance with the invention; and

FIG. 2 is a flow chart illustrating the method in accordance with the invention.

### DETAILED DESCRIPTION OF THE PREFERRED EMBODIMENTS

A printing machine has a sheet feeder and, in the region of printing units, at least one inking unit, respectively, and, downstream of the printing units, a sheet delivery. Usually, a plurality of printing units are connected in tandem. Print sheets to be imprinted are moved through the printing machine by a plurality of sheet guiding cylinders, some of which are constructed as transfer cylinders and others as impression cylinders. In the region of the inking units, a transfer cylinder or print blanket cylinder rolls on the impression cylinder. A form cylinder or plate cylinder which in turn carries at least one printing plate cooperates with the print blanket cylinder. Printing ink and prior to this, as the case may be, dampening medium, is applied to the printing plate, or to each printing plate, positioned on the plate cylinder by an inking unit with inking rollers and, as the case may be, a dampening unit with dampening rollers. For this purpose, the inking rollers and dampening rollers can be engaged and disengaged with respect to the plate cylinder in a position that forms contact with the printing plate and in a position that does not form contact with the printing plates. The printing ink is then applied as partial print image by the print blanket cylinder to the print sheets that are held in position at the impression cylinder.

The print sheets which are imprinted with a print image in the printing units in this way, and which are possibly provided with an additional coating in the coating unit in the form of a colored or clear top coat, are ejected from the printing machine by a conveyer system and are stacked in the sheet delivery. Here, each of the plate cylinders has at least one clamping groove in which clamping devices are integrated for the printing plate, or for each printing plate, to be positioned on the plate cylinder. An automatic plate changer is preferably associated with the plate cylinders, which makes it possible to automatically feed fresh printing plates to the plate cylinder or remove used printing plates from the plate cylinder.

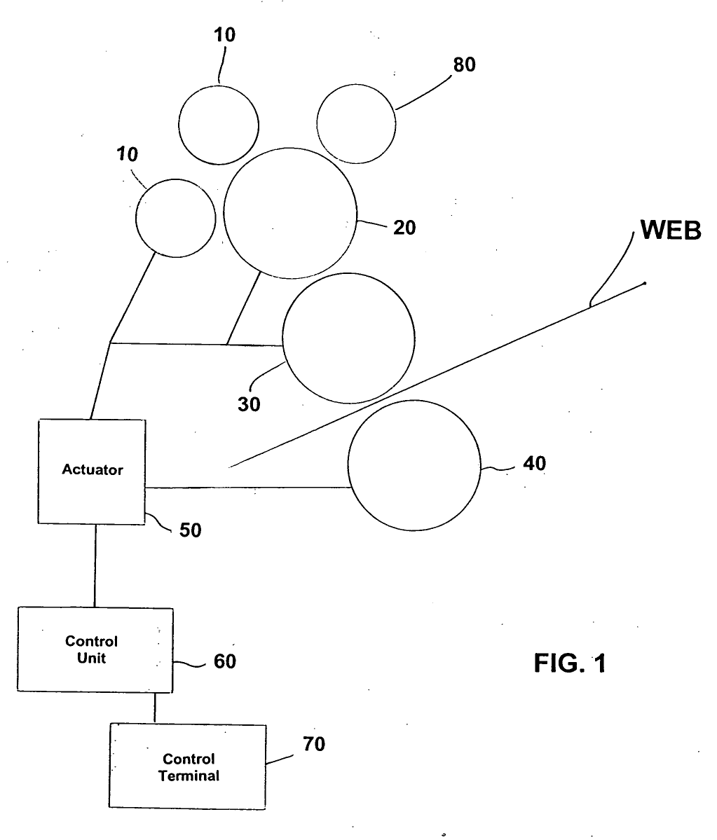

FIG. 1 is a schematic illustration of the printing unit of a printing machine in accordance with the invention. Within the context of the invention, the engagement and disengagement of the inking rollers 10 is performed such that the disengagement from the plate cylinder 20 is always performed before the end of the sheet run or transport of print sheets during a print run, where the adjustment of the plate cylinder 20, print blanket cylinder 30 and impression cylinder 40 in contact with one another is maintained constantly. As a result, at the end of a print run, print sheets still running through the printing machine remove printing ink from the plate cylinder by means of the print blanket cylinder without the inking unit continuing to supply printing ink to the printing plate. The residual printing ink is thus quickly removed from the print blanket cylinder 30, plate cylinder 20 and the printing plate fitted to the plate cylinder. The printing plate which is then substantially clean can then be removed without risk to the automatic plate changer and a new printing plate can be supplied.

The engagement and disengagement of the inking rollers and plate cylinders in the above-described manner is performed using actuators 50 which are controllable by a control unit 60 with respect to the working position of the printing machine. The actuators 50 are controlled in real-time by the control arrangement of the printing machine. Corresponding rate times or correction angles are provided depending on the machine speed to achieve a response of the actuators 50 that is timely. In preferred embodiments, the actuators 50 are pneumatic or hydraulic cylinder-valve units. In alternative embodiments, the actuators 50 are electric actuators or cam controls.

When a printing unit is switched from a printing ON setting to a printing OFF setting, the inking rollers 10 are preferably first disengaged from the plate cylinder 20 and the print blanket cylinder 30 is then disengaged from the impression cylinder 40 and from the plate cylinder 20.

In addition, the control device 60 can be used to determine a quantity of print sheets which are imprinted with an incomplete ink image by the printing ink that is still present on the print blanket cylinder 30 and printing plate after the printing unit and inking rollers 10 are switched to the printing OFF setting. The quantity of these print sheets can be entered in a control terminal 70 and determined such that every printing form positioned on the plate cylinder 20 has a defined residual ink layer thickness after the printing OFF setting has been assumed. In this type of de-inking, incomplete ink images are printed on the respective print sheet with a reduced application of ink, i.e., with a decreasing ink layer thickness due to the interrupted supply of ink from the inking unit to the printing plate and print blanket cylinder 30. As a result, the surfaces of the print blanket cylinder 30 and printing plate are substantially cleaned. Moreover, the risk of a large amount of ink drying up on the print blanket cylinder 30 or printing plate can also be avoided.

Sheet-fed printing machines in which the plate cylinders 20 are provided with separate individual drives which are mechanically separated from the other drives in the printing machine are generally known. An “on-the-fly” plate change is provided in connection with such a printing machine, which makes it possible to also exchange printing plates on individually selected plate cylinders by means of the individual drives. In so doing, the additional printing plates remain on the corresponding plate cylinders so that only a part of the total print image is exchanged. The foregoing procedure is useful when partial image contents, e.g., annotations in constantly changing languages, are to be printed in an otherwise static ink image.

The plate changing process performed on the fly corresponds, per se, to a conventional plate change. The on-the-fly plate change can be used to exchange one determined printing plate while continuing to directly use the same printing unit with the new printing plate for subsequent printing. However, it is also possible to provide an “on-the-fly” plate change in combination with another printing unit so that a second printing unit in which the printing plate with the new partial image is already inserted takes over the printing function of the first printing unit in which the plate is to be changed. As a result, it becomes possible to change from the second printing unit to the first printing unit in another on-the-fly plate change.

Therefore, the method of the invention for removing ink from the print blanket cylinder and the printing plate of printing print sheets or waste print sheets at the end of a print run is also useful in this case. However, the contemplated method of the invention is then only performed in the special printing unit that is removed from the printing process for changing the plate.

The procedure is modified somewhat insofar as a delay of the printing process is useful or even necessary for the on-the-fly plate changing process so that the respective printing unit can be put in operation again.

First, the print blanket cylinder 30 need not be washed and cleaned by a corresponding washing device, and the special printing plate need not be cleaned separately for use in an automatic plate changer. Naturally, the inking rollers 10 have also been disengaged beforehand for this operation. The surplus printing ink that remains on the print blanket cylinder 30 and plate cylinder 20 is then removed from the selected printing unit when the printing machine is braked prior to the on-the-fly plate change without feeding in additional waste print sheets. However, waste paper can already normally result when the printing machine is braked. As a result, this waste paper can be used directly for ink removal.

The possibility of removing the majority of the remaining residual ink using waste sheets is provided so that the printing plates can be removed from the printing machine without additional cleaning and without excessively soiling the transport rollers of the automatic plate changers. Hence, with the print blanket cylinder 30 engaged, the inking rollers 10 and dampening rollers 80 are disengaged from the plate cylinder at the moment of a pre-selectable quantity of sheets prior to the final cessation of printing. The quantity of sheets is predetermined in a printer menu at the control device 60 of the printing machine, e.g., at the control terminal 60. For example, a value ranging from 0 to 100 can be entered at the control terminal to determine this quantity. In practice, up to 65 de-inking sheets are used. When production is terminated by the expiration of a circulation counter of the printer control or by a control button at the control terminal 70, the inking rollers 10 and dampening rollers 80 are automatically switched off earlier while printing continues, and the corresponding quantity of print sheets is transported through the printing machine.

In the method according to the invention, the inking rollers and dampening rollers 80 are preferably disengaged simultaneously, because when the inking rollers 10 are disengaged while the dampening rollers 80 are still engaged, less ink is removed from the print blanket cylinder 30 by the printing sheets as well as between the plate cylinder 20 and print blanket cylinder 30. As a result, an inferior cleaning effect for the printing plates is avoided.

Alternatively, a delayed or separate disengagement of the dampening rollers 80 may be useful as a procedure for special subjects, substrates or printing inks. Delayed dampening of the printing plate advantageously achieves a cleaning action on the printing plate for contamination other than that caused by printing ink. This is a possibility for subjects with limited coverage or for dust-producing substrates. Further, certain printing inks tend to split, which can be prevented by prolonged dampening of the printing plate. In addition, the ability to perform a corresponding adjustment at the printing unit and at the inking rollers 10 and dampening rollers 80 is provided for this purpose.

The process of de-inking is modified when it is performed in a printing machine which is outfitted with one or more coating units, e.g., for gloss coating of the print sheets. The process of de-inking can then be performed, alone or in combination with a process for removing residual coating.

The coating units are preferably switched off at least with a delay after switching off the inking rollers 10 and dampening rollers 80. As a result, the waste sheets are still adequately covered with varnish or coating medium during the de-inking. Therefore, damp printing ink present on the waste sheet can split on a coating plate mounted on a coating form cylinder of the coating unit or on a corresponding printing blanket and can contaminate the latter in an undesirable manner.

In an embodiment, a coating roller in a coating unit can be disengaged from the coating form cylinder and/or the coating form cylinder can be disengaged from the impression cylinder. Here, a reaction is achieved which is appreciably faster than if only the coating supply in the coating unit were disengaged. As a result, a fast and reliable prevention of splitting of the printing ink on elements of the coating unit is achieved, while simultaneously making it possible to control the removal of the residual coating from the elements of the coating unit in a precise manner.

In another embodiment, a removal of residual coating is provided. Here, a residual amount of varnish or a residual amount of coatings medium is removed from the coating unit. In accordance with the contemplated embodiments of method, however, the coating removal should not be performed until the ink remaining on the plate cylinder and print blanket cylinder has been minimized. Therefore, a predetermined quantity of print sheets runs through the printing machine for removing printing ink with the inking rollers and dampening rollers disengaged and the print blanket cylinder engaged at the plate cylinder and impression cylinder, while the coating unit or coating units are still in operation and a separation of printing ink from the print sheets on coating forms or print blankets in the coating units is safely prevented. It is only after performing the foregoing that it becomes possible to convey a predetermined quantity of additional print sheets through the printing machine and the coating units to remove the residual varnish or residual coating medium that is still present in the coating units.

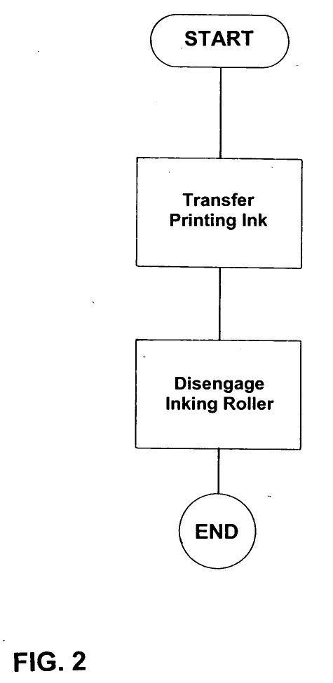

FIG. 2 is a flow chart illustrating the method in accordance with the invention. Generally, the steps of the method comprises transferring printing ink to print sheets transferring printing ink to print sheets and disengaging the inking roller relative to the plate cylinder 20. More specifically, however, the steps of method are implementing in printing unit having the inking unit and a dampening unit as follows.

A determined quantity of (waste) print sheets is initially supplied in the sheet feed. A determined quantity of (waste) print sheets is preselected at the control terminal of the printing machine.

Next, parameters are stored (possibly in a job-specific manner). The inking rollers and possibly the dampening rollers are disengaged from the plate cylinder in a pre-selected or automated manner corresponding to the preselected determined quantity of (waste) print sheets. Printing ink is then removed from the print blanket cylinder by the (waste) print sheets that are conveyed through the printing machine in a pre-selected manner.

The printing ink is removed from the plate cylinder and the printing plate by the print blanket cylinder and by the (waste) print sheets that are conveyed through the printing machine. The supply of coating to the coating unit or coating units is switched off with a delay to prevent the separation of printing ink from the (waste) print sheets in the coating units; alternatively, the coating roller(s) is (are) disengaged in the coating unit. In an embodiment, the residual coating is optionally removed from the coating plate or printing blanket in the coating unit by the (waste) print sheets which are conveyed through the printing machine.

The printing plate to be changed is now removed from the printing units without further cleaning. The coating plates to be changed, as the case may be, are also removed without further cleaning.

A quantity of print sheets that can be determined by the control device or at the control terminal run though the inking unit without any ink being applied between a printing OFF setting of the inking unit and a printing ON setting of the inking unit or between two printing ON settings with a printing OFF setting interposed therebetween. As a result, it becomes possible to shunt out of the printing process a specific quantity of print sheets which are moved through the printing units without any ink being supplied from the inking unit. These incompletely inked print sheets can be used, for example, for measuring purposes. The incompletely imprinted print sheets can be shunted out automatically by a sheet shunt or by a dual delivery arrangement.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An inking unit in a printing machine having an ink supply system, comprising:
an inking roller and a form cylinder carrying at least one printing form, the inking roller transferring printing ink to the at least one printing form and each printing form being positioned on the form cylinder;
a dampening unit having dampening rollers associated with the form cylinder, said printing ink being one of directly transferable and transferred by a print blanket cylinder from a respective printing form to print sheets moved between the form cylinder and an impression cylinder, and said inking roller being adjustable relative to the form cylinder,
wherein at least one of disengagement of the inking roller and dampening rollers relative to the form cylinder and disengagement of the print blanket cylinder relative to the impression cylinder is performable such that print sheets in a printing ON setting for a pre-selectable quantity of sheets are imprinted with an ink image without the printing ink being supplied by the inking rollers.

2. The inking unit according to claim 1, wherein at least one of the disengagement of the inking roller and dampening rollers relative to the form cylinder or coating form cylinder and the disengagement of the print blanket cylinder or coating form cylinder relative to the impression cylinder is performable such that print sheets in the printing ON setting for the pre-selectable quantity of sheets are imprinted with an ink image without the printing ink being supplied by the inking rollers, wherein a coating continues to be performed.

3. The inking unit according to claim 1, wherein at least one of the inking roller and the dampening rollers in the printing ON setting between the form cylinder and print blanket cylinder and impression cylinder is disengageable from the form cylinder, and the print blanket cylinder is disengageable from the form cylinder and the impression cylinder or initially from the form cylinder and subsequently from the impression cylinder.

4. The inking unit according to claim 1, wherein at least one of the inking roller and the dampening rollers in the printing ON setting between the form cylinder and print blanket cylinder and impression cylinder is disengageable from the form cylinder, and subsequently the print blanket cylinder is one of disengageable from the form cylinder and the impression cylinder and initially from the form cylinder and subsequently from the impression cylinder, and
wherein the coating form cylinder is subsequently disengageable from the impression cylinder.

5. The inking unit according to claim 1, further comprising a control device configured to determine the quantity of print sheets to be imprinted by a residual ink image before adopting a printing OFF setting.

6. The inking unit according to claim 5, wherein the quantity of print sheets to be imprinted is determinable such that the inking roller and the printing form, or each printing form, positioned on the form cylinder has a defined residual ink layer thickness after the printing OFF setting is adopted.

7. The inking unit according to claim 6, wherein the defined residual ink layer thickness is a minimal thickness.

8. The inking unit according to claim 5, wherein the control device automatically reduces a production speed at least one of before the printing OFF setting is adopted and during the printing OFF setting.

9. The inking unit according to claim 1, further comprising a control device configured to determine a quantity of print sheets running through the printing unit prior to a printing OFF setting without a supply of ink and a steadily decreasing application of ink.

10. A method for operating inking units in a printing machine, comprising:
transferring printing ink to print sheets from an inking roller of an ink dispensing system to at least one printing form positioned on a form cylinder and at least one printing form; and
disengaging the inking roller relative to the plate cylinder and at least one of engaging the print blanket cylinder relative to the impression cylinder and disengaging the print blanket cylinder relative to the impression cylinder such that print sheets are imprinted with a residual amount of printing ink remaining on the print blanket cylinder and printing plate in a printing ON setting of the blanket cylinder with the disengaged inking roller.

11. The method according to claim 10, further comprising:
determining a quantity of print sheets to be imprinted with a residual ink image before a printing OFF setting is adopted such that at least one printing form positioned on the form cylinder after the printing OFF setting is adopted has one of a minimum residual ink layer thickness and a residual ink layer thickness which approaches zero.

12. The method according to claim 11, further comprising:
reducing a production speed automatically at least one of before and during the printing OFF setting.

13. The method according to claim 10, further comprising:
determining a quantity of print sheets which run though the inking unit without any ink being applied by the inking unit between two printing ON settings and a printing OFF setting interposed therebetween.
